(19) United States
(12) Patent Application Publication
(10) Pub. No.: US 2014/0160039 A1
(43) Pub. Date: Jun. 12, 2014

(54) Electronic Apparatus, Control Method of an Electronic Apparatus, And Computer Readable Storage Medium

(71) Applicant: Kabushiki Kaisha Toshiba, Tokyo (JP)

(72) Inventor: Tomohiro Hanyu, Ome-shi (JP)

(21) Appl. No.: 13/942,222

(22) Filed: Jul. 15, 2013

(30) Foreign Application Priority Data
Dec. 11, 2012 (JP) 2012-270846

(51) Int. Cl. G06F 3/0488

(52) U.S. Cl. CPC G06F 3/0488
USPC 345/173

(57) ABSTRACT

An electronic apparatus includes a touch manipulation portion, a touch input detector, a user manipulation portion, and an operation module. The touch manipulation portion is configured to receive a multitouch input. The touch input detector is configured to detect a single touch input that is made with the touch manipulation portion. The user manipulation portion is provided separately from the touch manipulation portion and can be manipulated by a user. The operation module is configured, when the touch input detector detects the single touch input and the user manipulation portion is manipulated, to perform an operation that is similar to an operation to be performed in response to the multitouch input.

### CROSS-REFERENCE TO RELATED APPLICATION(S)

The present disclosure claims priority to Japanese Patent Application No.2012-270846, filed on Dec. 11, 2012, which is incorporated herein by reference in its entirety.

### FIELD

Embodiments described herein relate generally to an electronic apparatus, a control method of an electronic apparatus, and a computer readable storage medium.

### BACKGROUND

In recent years, electronic apparatus which enable multitouch manipulation (input) have come into wide use.

The term “multitouch manipulation (input)” means an input method which allows a user to perform a manipulation by simultaneously touching plural points of an input device which can be manipulated by touching it with a user finger(s), a pen(s), or the like.

For example, in the multitouch input method, a user can touch plural points simultaneously and input an instruction relating to a position and/or a movement for each point.

For another example, the multitouch input method allows plural users to use an input device having a large screen simultaneously or allows a user to intuitively input a movement such as a translation and/or a rotation of a subject or image zooming by a manipulation with plural fingers.

The multitouch manipulation (input) is convenient. However, when such an electronic apparatus is in a situation where the user has difficulty in making a multitouch manipulation (input) (e.g., only one hand of the user is usable and the user is going to make a multitouch manipulation with the one hand while holding the electronic apparatus with the same hand), it is very difficult to cause the electronic apparatus to operate by the multitouch manipulation (input). This is inconvenient to the user.

Thus, as for electronic apparatus which can receive a multitouch manipulation (input), it is desired to cause an electronic apparatus to operate in the same manner as when it receives a multitouch manipulation (input) even in such a situation where the user has difficulty in making a multitouch manipulation (input).

### BRIEF DESCRIPTION OF THE DRAWINGS

FIG. 1 shows an appearance of an electronic apparatus according to one embodiment;

FIG. 2 is a block diagram showing the configuration of the electronic apparatus according to the embodiment;

FIGS. 3A and 3B illustrate how the electronic apparatus according to the embodiment performs an operation (a pinch-out (zooming-in) operation) that is similar to an operation to be performed in response to a multitouch manipulation (input);

FIGS. 4A to 4C are a flowchart showing how the electronic apparatus according to the embodiment performs the operation (the pinch-out (zooming-in) operation), which is similar to the operation to be performed in response to the multitouch manipulation (input);

FIGS. 5A and 5B illustrate how the electronic apparatus according to the embodiment performs an operation (a pinch-in (zooming-out) operation) that is similar to an operation to be performed a multitouch manipulation (input);

FIGS. 6A to 6C are a flowchart showing how the electronic apparatus according to the embodiment performs the operation (the pinch-in (zooming-out) operation), which is similar to the operation to be performed in response to the multitouch manipulation (input); and

FIG. 7 shows an appearance of an electronic apparatus according to another embodiment.

### DETAILED DESCRIPTION

According to one embodiment, an electronic apparatus includes a touch manipulation portion, a touch input detector, a user manipulation portion, and an operation module. The touch manipulation portion is configured to receive a multitouch input. The touch input detector is configured to detect a single touch input that is made with the touch manipulation portion. The user manipulation portion is provided separately from the touch manipulation portion and can be manipulated by a user. The operation module is configured, when the touch input detector detects the single touch input and the user manipulation portion is manipulated, to perform an operation that is similar to an operation to be performed in response to the multitouch input.

Embodiments will be hereinafter described with reference to the accompanying drawings.

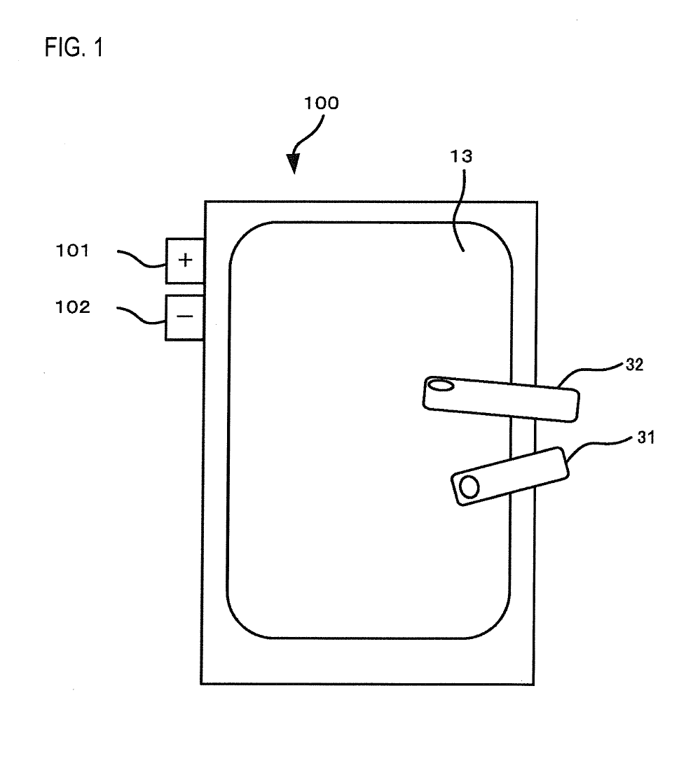

FIG. 1 shows an appearance of an electronic apparatus 100 according to one embodiment.

In this embodiment, the electronic apparatus (tablet apparatus) 100 can receive a multitouch manipulation (input). For example, the whole or a part of a video display (LCD) 13 is equipped with a touch manipulation portion that can receive the multitouch manipulation.

The touch manipulation portion can also detect a single touch manipulation (input) (touch input detector).

In this embodiment, the electronic apparatus (tablet apparatus) 100 is also equipped with user manipulation portions (a first manipulation portion 101 and a second manipulation portion 102) that are provided separately from the touch manipulation portion and can be manipulated by a user.

If a single touch is detected and if the user manipulation portion (the first manipulation portion 101, the second manipulation portion 102) is manipulated, the electronic apparatus (tablet apparatus) 100 performs an operation that is similar to an operation to be performed in response to a multitouch manipulation.

The term “single touch manipulation (input)” means a method that allows a user to perform a manipulation using an input device configured to be manipulated by touching it with a user finger, a pen, or the like. It is noted that the single touch manipulation (input) is a method that allows a user to perform the manipulation by touching a single point on the input device, unlike a multitouch manipulation which allows a user to perform a manipulation by simultaneously touching plural points on an input device.

That is, in the single touch manipulation, only one point on the input device is specified.

As shown in FIG. 1, a user can perform a multitouch manipulation on the electronic apparatus (tablet apparatus) 100 using his or her index finger 32 and thumb 31, for example.

As mentioned above, in this embodiment, the electronic apparatus (tablet apparatus) 100 is equipped with the user manipulation portions (the first manipulation portion 101 and the second manipulation portion 102), which can be manipulated by the user.

Here, these user manipulation portions (the first manipulation portion 101 and the second manipulation portion 102) are provided separately from the touch manipulation portion (the whole or a part of the video display 13).

For example, these user manipulation portions (the first manipulation portion 101 and the second manipulation portion 102) may be manipulation buttons (the first manipulation portion 101 and the second manipulation portion 102) which are provided on a side surface of a main body of the electronic apparatus (tablet apparatus) 100.

In FIG. 1, the first manipulation portion 101 is given a mark “+,” and the second manipulation portion 102 is given a mark “−.”

In this embodiment, when, for example, the user manipulation portion (the first manipulation portion 101, the second manipulation portion 102) is manipulated following a single touch manipulation (input), the electronic apparatus (tablet apparatus) 100 can emulate, for example, a pinch manipulation (a kind of multitouch manipulation; a manipulation of making two fingers come closer to or go away from each other).

In this embodiment, description will be give with reference to the tablet apparatus as an example of the electronic apparatus. However, in this embodiment, the electronic apparatus is not limited to the tablet apparatus and encompasses ones having a touch manipulation portion that can receive a multitouch manipulation (input) such as a TV receiver, a personal computer (PC), a smartphone, and a portable terminal.

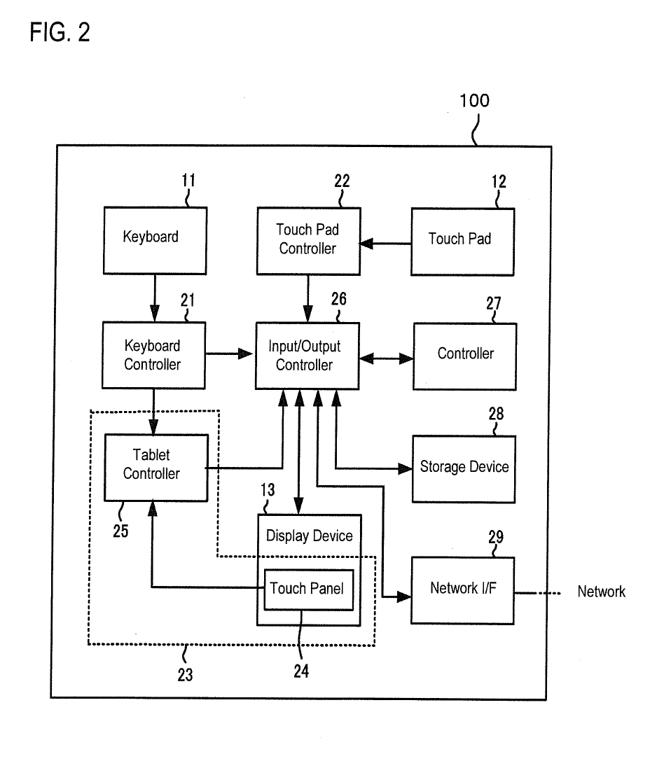

FIG. 2 is a block diagram showing the configuration of the electronic apparatus according to the embodiment.

As shown in FIG. 2, the electronic apparatus (tablet apparatus) 100 is equipped with a keyboard controller 21 configured to convert key inputs received through a keyboard 11 into input data and input the input data to the computer main body.

Also, the electronic apparatus (tablet apparatus) 100 is equipped with a touch pad controller 22 configured to convert a manipulation input received through a touch pad 12 into input data and input the input data to the computer main body.

Furthermore, the electronic apparatus (tablet apparatus) 100 is equipped with a tablet-type input device 23 as a data input device, as well as the keyboard 11 and the touch pad 12.

The tablet-type input device 23 includes a tablet (touch panel) 24 and a tablet controller 25 configured to convert position coordinates of a pen, a finger, or the like that is detected by the tablet (touch panel) 24 and an area of its contact surface into input data.

The computer main body also has an input/output controller 26.

The input/output controller 26 transfers, to a microprocessor (CPU) provided in a controller 27, data that is input from the keyboard controller 21, the touch pad controller 22, and/or the tablet controller 25. Also, the input/output controller 26 controls an output operation of the display device 13 and an input/output operation of a storage device 28 such as an HDD or an SSD (solid-state drive), under the control of the controller 27.

The controller 27 includes memory devices such as a system memory (RAM) into which an OS and various applications are to be loaded and which is used as a work area, a BIOS, and a ROM.

A network interface (I/F) 29 that is connected to the input/output controller 26 is an interface for connection to an external server (not shown) or the like via a network such as the Internet or a LAN (local area network).

The electronic apparatus (tablet apparatus) 100 can download a desired program or content from an external server or the like through the network I/F 29.

In this embodiment, either of a wireless LAN or a wired LAN may be used as the network.

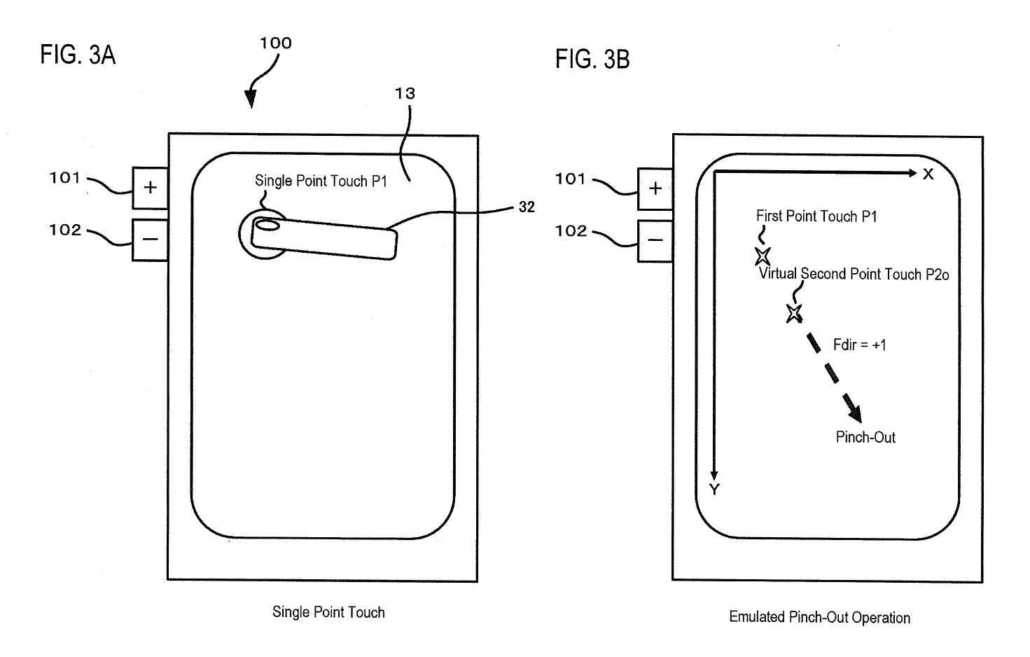

FIGS. 3A and 3B illustrate how the electronic apparatus (tablet apparatus) 100 according to the embodiment performs an operation that is similar to an operation (a pinch-out (zooming-in) operation) to be performed in response to a multitouch manipulation (input).

FIG. 3A shows the electronic device (tablet apparatus) 100, which is equipped with the touch manipulation portion (the whole or a part of the video display 13) which can receive a multitouch manipulation (input).

The electronic apparatus (tablet apparatus) 100 can detect a single touch manipulation (input) that is performed using the touch manipulation portion (touch input detector).

In this embodiment, the electronic apparatus (tablet apparatus) 100 is also equipped with the user manipulation portions (the first manipulation portion 101 and the second manipulation portion 102), which are provided separately from the touch manipulation portion and which can be manipulated by a user.

FIG. 3A shows that a user touches (manipulates) the touch manipulation portion (the entire or a part of the video display 13) with his or her index finger 32 to make a single touch (single point touch) P1.

FIG. 3B shows how the electronic apparatus (tablet apparatus) 100 according to this embodiment emulates a pinch-out (zooming-in) operation.

The emulation will be described below. The emulation means, for example, running software that was developed for certain hardware on another hardware that is different in design from the certain hardware.

For example, to absorb differences in hardware design, software called an “emulator” is run which pretends to be original hardware. Then, software concerned is run on the emulator.

Performing, by software or another hardware, a process that is similar to a process performed by particular hardware may also be called emulation.

In this embodiment, when a user performs the above-described single touch manipulation (input) on the touch manipulation portion and the electronic apparatus (tablet apparatus) 100 detects the above-described single touch manipulation (input) (single touch (single point touch) P1, the user subsequently manipulates the user manipulation portion (the first manipulation portion 101, the second manipulation portion 102).

FIG. 3B shows when the user manipulation portion (the first manipulation portion 101, the second manipulation portion 102) is manipulated, the electronic apparatus (tablet apparatus) 100 performs an operation that is similar to an operation to be performed in response to a multitouch manipulation (input).

As described above, in the embodiment, the electronic apparatus (tablet apparatus) 100 is equipped with the touch manipulation portion (for example, the touch panel 24) which can recognize a multitouch manipulation (input) and a single touch manipulation (input) made by a user.

Also, for the purpose of emulating the multitouch manipulation (input) made with a single hand of a user, the two buttons of the “+” button 101 and “−” button 102 are provided.

For example, in the touch manipulation portion (for example, the touch panel 24), functions of zooming-in and zooming-out a content being displayed on a screen (the video display 13) are assigned to pinch manipulations.

The term “pinch manipulation” means a manipulation that a user makes his or her two fingers come closer to or go away from each other while keeping the two fingers in contact with the touch manipulation portion (for example, the touch panel 24).

In many cases, a user performs the pinch manipulation by two fingers of one hand (e.g., right hand) when the user is holding the electronic apparatus (tablet apparatus) 100 with the other hand (e.g., left hand).

Therefore, it is not easy for the user to make the pinch manipulation by the multitouch manipulation (input) in a situation where the user can use only one hand, for example, in a situation where the user is holding something or carrying a bag or the like with one hand (left hand) and is holding the electronic apparatus (tablet apparatus) 100 with the other hand (right hand).

In contrast, in this embodiment, for example, the user can manipulate the user manipulation portion (the first manipulation portion 101, the second manipulation portion 102) with one hand (right hand) while holding the electronic apparatus (tablet apparatus 100) with the same hand.

Reference numeral 101 indicates one of the two buttons to emulate the multitouch manipulation (input) made by a single hand. For example, the button 101 is the “+” button (zooming-in button) to emulate “pinch-out (zooming-in).”

The button 101 needs not always be a button dedicated to the emulation of the “pinch-out (zooming-in).” The button 101 may also serve as a volume-up button to turn up volume.

Reference numeral 102 indicates the other of the two buttons to emulate the multitouch manipulation (input) made by a single hand. For example, the button 102 is the “−” button (zooming-out button) to emulate “pinch-in (zooming-out).”

The button 102 need not always be a button dedicated to the emulation of the “pinch-in (zooming-out). The button 102 may also serve as a volume-down button.

The pinch-out (zooming-in) is a manipulation method that may also be called “pinch-open.” The pinch-out is an action of placing two fingers on a screen and moving the two fingers away from each other.

In general, the pinch-out is a manipulation for zooming-in and can zoom in an image displayed on a screen of a tablet device, a smartphone, or the like.

The pinch-in (zooming-out) is, for example, a manipulation that is used when in an image displayed on a screen of a tablet device, a smartphone, or the like is zoomed out. The pinch-in (zooming-out) can make a displayed image small. The pinch-in (zooming-out) may also be called “pinch close.”

In this embodiment, if a user makes a single touch manipulation (input) on the touch manipulation portion and then manipulates one of the user manipulation portions (in the example of FIGS. 3A and 3B, the first manipulation portion 101 which the “+” mark is given), the electronic apparatus (tablet apparatus) 100 emulates the pinch-out (zooming-in) operation that is similar to the operation to be performed in response to the multitouch manipulation (input), that is, emulates the multitouch manipulation (input) (the pinch-out (zooming-in) operation).

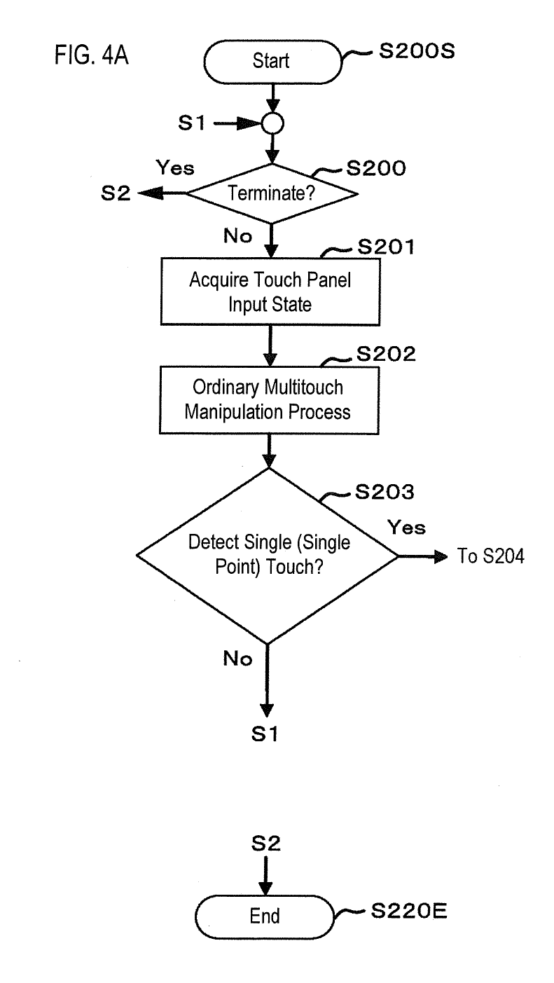

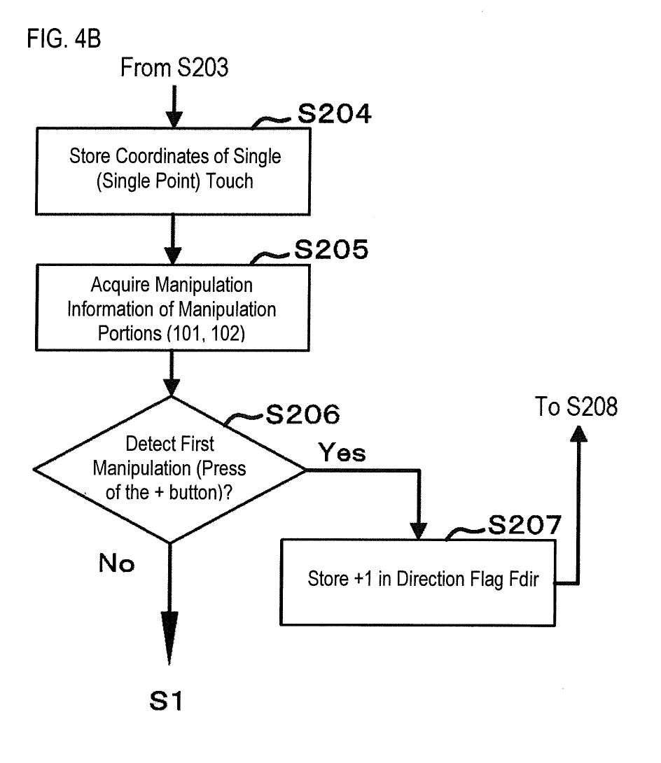

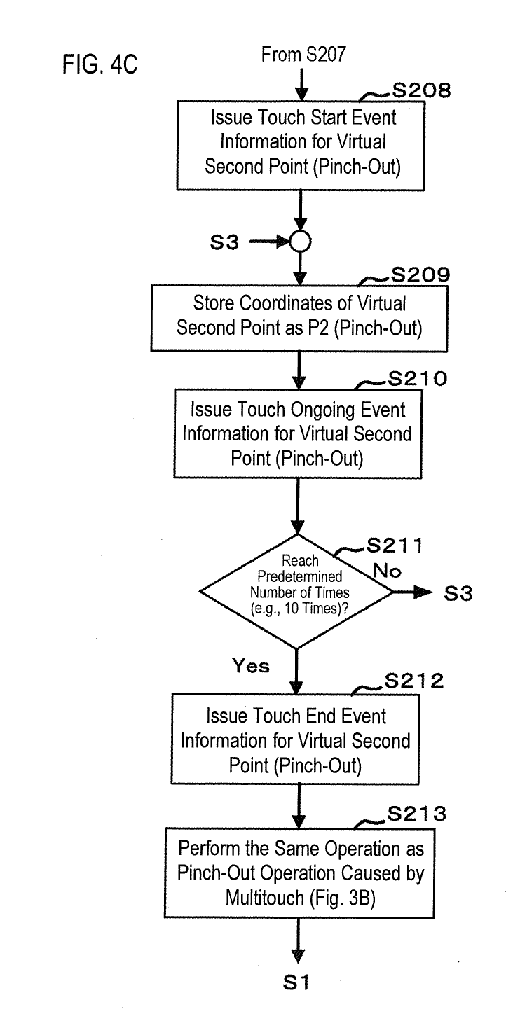

FIGS. 4A to 4C are a flowchart showing how the electronic apparatus performs an operation (the pinch-out (zooming-in) operation) that is similar to the operation to be performed in response to the multitouch manipulation (input).

The process starts at step S200S. Then, the process proceeds to step S200.

At step S200, it is determined as to whether or not the process should be terminated. If the process should not be terminated (No at S200), the process proceeds to step S201. If the process should be terminated (Yes at S200), the process proceeds to step S220E via S2.

At step S201, a user's input state to the touch manipulation portion (the touch panel 24) is acquired. Specifically, a touch manipulation state (“touch start state,” “touch ongoing state,” or “touch end state”) and a position(s) (coordinates) of the touch manipulation are acquired.

In this embodiment, plural sets of coordinates are acquired in the case of a multitouch manipulation. Then, the process proceeds to step S202.

At step S202, an ordinary process (e.g., issuance of touch event information) for the multitouch manipulation (input) is performed according to the user's input state to the touch manipulation portion.

The above-mentioned user's input states include (i) the “touch stare state,” which is a state where a finger has been brought into contact with and is still in contact with the touch manipulation portion, (ii) the “touch ongoing state,” which is a state where a finger is being moved while kept in contact with the touch manipulation portion, and (iii) the “touch end state,” which is a state where a finger is separate from the touch manipulation portion.

In the ordinary process which is performed according to each user input state, event information corresponding to each user input state is issued together with position information (coordinates).

The software of the electronic apparatus (tablet apparatus) 100 receives the thus-notified event information and performs a process that is suitable for the kind of the event (user's input state) and the position information (coordinates).

In addition to the above, in this embodiment, for example, not the multitouch manipulation (input) by a user but a single touch (single point touch) manipulation is performed for the touch manipulation portion (the touch panel 24) and is detected.

For example, at step S202, the single touch (single point touch) manipulation is performed and detected. Then, the process proceeds to step S203.

At step S203, it is determined as to whether or not a single touch (single point touch) manipulation has been performed. That is, at step S203, it is determined as to whether or not user's input is in a “first-point touch (single point touch) start state” (where a finger has been brought into contact with a single point on the touch manipulation portion (the touch panel 24) and is still in contact therewith).

If it is detected that the single touch (single point touch) manipulation is performed (Yes at S203), the process proceeds to step S204. If not (No at S203), the process returns to step S200 to repeat the above process. That is, the process proceeds to step S200 and establishes a state for receiving next input from the user.

At step S204, a position (coordinates) where the first-point touch (single touch) start state is established is stored in, for example, the storage device 28 as P1(x1,y1). Then, the process proceeds to step S205.

At step S205, manipulation information of the user manipulation portions (the first manipulation portion 101, the second manipulation portion 102) are acquired. For example, a push/non-push state of the “+” button (the first manipulation portion 101) and a push/non-push state of the “−” button (the second manipulation portion 102) are acquired. Then, the process proceeds to step S206.

At step S206, it is determined as to whether or not the first manipulation portion (“+” button) 101 of the user manipulation portions is manipulated. If it is determined that the first manipulation portion (“+” button) 101 of the user manipulation portions is manipulated (Yes at S206), the process proceeds to step S207. If not (Not at S206), the process returns to step S200 via S1.

At step S207, for example, a value “+1” is stored in a direction flag Fdir as shown in FIG. 3B. Then, the process proceeds to step S208.

At step S208, touch start event information for a virtual second point of “pinch-out (zooming-in)” is issued.

In this embodiment, the term “virtual second point” means a point at which input is not actually performed through the touch manipulation portion (the touch panel 24) and which is generated by the emulation as a second point that is necessary for the pinch-out (zooming-in) operation.

For example, it is assumed that Dpinch represents a predetermined distance between two points and Doffset represents an offset for Dpinch (Doffset<Dpinch). Then, coordinates P2(x2, y2) of the virtual second point are calculated using the coordinates P1(x1, y1) of the first point, the distance Dpinch, the offset Doffset, and the direction flag Dfir according to the following equation:

$$\begin{matrix}P 2 ( x 2 , y 2 ) = P 1 ( x 1 , y 1 ) + ( Dpinch - Fdir \times Doffset ) \\ = ( x 1 + ( \begin{matrix}Dpinch - \\ Fdir \times Doffset\end{matrix} ) , y 1 + ( \begin{matrix}Dpinch - \\ Fdir \times Doffset\end{matrix} )\end{matrix}$$

Then, in the case of pinch-out, the point P2(P2o) can be set at a position that is close to the point P1 by correcting the distance by Doffset using Fdir. Then, the process proceeds to step S209.

At step S209, the thus-calculated coordinates P2 (P2o) are stored as coordinates of the virtual second point (for pinch-out (zooming-in)). Then, the process proceeds to step S210.

At step S210, touch ongoing event information for the virtual second point is issued (for pinch-out (zooming-in)). This is to emulate the same action (the same manipulation) as an action in which fingers are moved for a pinch-out manipulation on the touch manipulation portion (touch panel 24).

For example, it is assumed that Dmove represent a predetermined movement distance. Then, coordinates P2′ after a movement emulation is given by

$$\begin{matrix}P {2}^{′} ( x {2}^{′} , y {2}^{′} ) = P 2 + Fdir \times Dmove \\ = ( x 2 + Fdir \times Dmove , y 2 + Fdir \times Dmove ) .\end{matrix}$$

The above operation is repeated a predetermined number of times (e.g., 10 times) while P2′ is substituted into P2.

As a result of repeating the processes, in the case of pinch-out (zooming-in), the point P2o changes so as to go away from the point P1 (see FIG. 3B).

That is, an action can be emulated that is the same as the action in which fingers are moved for the pinch-out manipulation by issuing the touch ongoing event information at the position P2 when P2′ is substituted into P2. Then, the process proceeds to step S211.

At step S211, it is determined as to whether or not the above operation has been performed the predetermined number of times (e.g., 10 times). If it is determined that the above operation has been performed the predetermined number of times (Yes at S211), the process proceeds to step S212. If not (No at S211), the process returns to step S209 via S3 and the above process is repeated.

At step S212, touch end event information for the virtual second point is issued (for pinch-out (zooming-in)). Then, the process proceeds to step S213.

At step S213, for example, application software (not shown) that is provided inside or outside the electronic apparatus (tablet apparatus) 100 performs the same operation as the pinch-out (zooming-in) operation for the multitouch manipulation (input) in the manner shown in FIG. 3B. Then, the process returns to step S200 via S1, and the above process is repeated.

Also, step S2 leads to step S220E.

The process is terminated at step S220E.

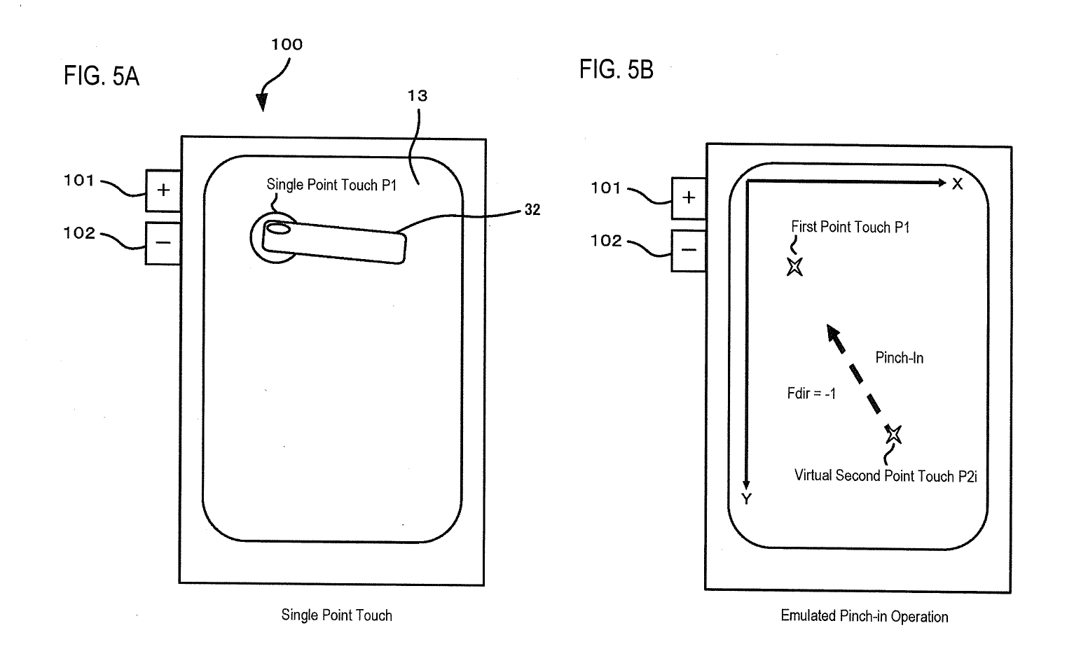

FIGS. 5A and 5B illustrate how the electronic apparatus (tablet apparatus) 100 according to the embodiment performs an operation that is similar to an operation (a pinch-in (zooming-out) operation) to be performed in response to the multitouch manipulation (input).

FIG. 5A shows the electronic apparatus (tablet apparatus) 100, which is equipped with the touch manipulation portion (the whole or a part of the video display 13) which can receive a multitouch manipulation (input).

FIG. 5A also shows a user touches (manipulates) the touch manipulation portion (the entire of a part of the video display 13) with his or her index finger 32 to make a single touch (single point touch) P1.

FIG. 5B shows how the electronic apparatus (tablet apparatus) 100 according to this embodiment emulates a pinch-in (zooming-out) operation.

In this embodiment, for example, the user can manipulate the user manipulation portion (the first manipulation portion 101, the second manipulation portion 102) with one hand (right hand) while holding the electronic apparatus (tablet apparatus 100) with the same hand.

Reference numeral 102 indicates one of the two buttons to emulate the multitouch manipulation (input) made by a single hand. For example, the button 102 is the “−” button (zooming-out button) to emulate “pinch-in (zooming-out).”

The button 102 needs not always be a button dedicated to the emulation of the “pinch-in (zooming-out).” The button 102 may also serve as a volume-down button to lower down volume.

The pinch-in (zooming-out) is, for example, a manipulation that is used when in an image displayed on a screen of a tablet device, a smartphone, or the like is zoomed out. The pinch-in (zooming-out) can make a displayed image small. The pinch-in (zooming-out) may also be called “pinch close.”

In this embodiment, if a user makes a single touch manipulation (input) on the touch manipulation portion and then manipulates one of the user manipulation portions (in the example of FIGS. 5A and 5B, the second manipulation portion 102 which the “−” mark is given), the electronic apparatus (tablet apparatus) 100 emulates the pinch-in (zooming-out) operation that is similar to the operation to be performed in response to the multitouch manipulation (input), that is, emulates the multitouch manipulation (input) (the pinch-in (zooming-out) operation).

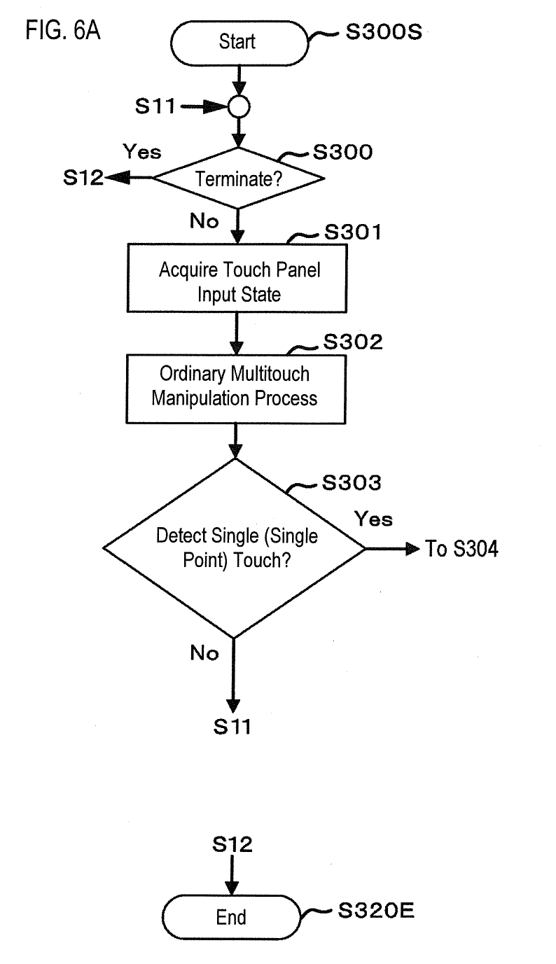

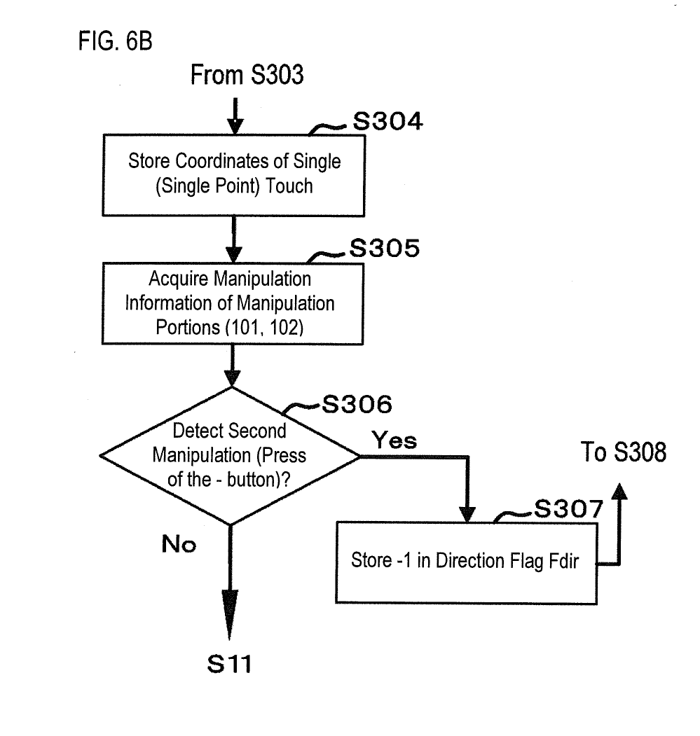

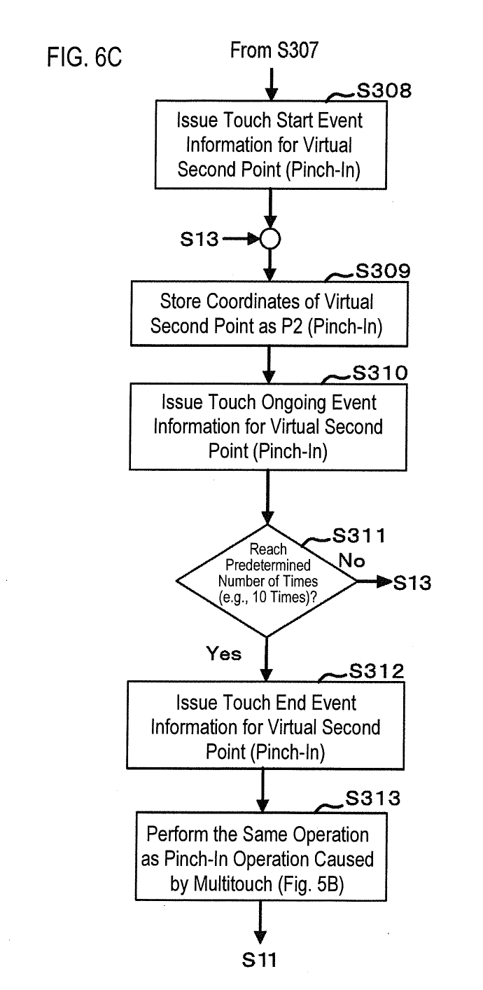

FIGS. 6A to 6C are a flowchart showing how the electronic apparatus performs an operation (the pinch-in (zooming-out) operation) that is similar to the operation to be performed in response to the multitouch manipulation (input).

The process starts at step S300S. Then, the process proceeds to step S300.

At step S300, it is determined as to whether or not the process should be terminated. If the process should not be terminated (No at S300), the process proceeds to step S301. If the process should be terminated (Yes at S300), the process proceeds to step S320E via S12.

At step S301, a user's input state to the touch manipulation portion (the touch panel 24) is acquired. Specifically, a touch manipulation state (“touch start state,” “touch ongoing state,” or “touch end state”) and a position(s) (coordinates) of the touch manipulation are acquired.

In this embodiment, plural sets of coordinates are acquired in the case of a multitouch manipulation. Then, the process proceeds to step S302.

At step 3202, an ordinary process (e.g., issuance of touch event information) for the multitouch manipulation (input) is performed according to the user's input state to the touch manipulation portion.

The above-mentioned user's input states include (i) the “touch stare state,” which is a state where a finger has been brought into contact with and is still in contact with the touch manipulation portion, (ii) the “touch ongoing state,” which is a state where a finger is being moved while kept in contact with the touch manipulation portion, and (iii) the “touch end state,” which is a state where a finger is separate from the touch manipulation portion.

In the ordinary process which is performed according to each user input state, event information corresponding to each user input state is issued together with position information (coordinates).

The software of the electronic apparatus (tablet apparatus) 100 receives the thus-notified event information and performs a process that is suitable for the kind of the event (user's input state) and the position information (coordinates).

In addition to the above, in this embodiment, for example, not the multitouch manipulation (input) by a user but a single touch (single point touch) manipulation is performed for the touch manipulation portion (the touch panel 24) and is detected.

For example, at step S302, the single touch (single point touch) manipulation is performed and detected. Then, the process proceeds to step 303.

At step S303, it is determined as to whether or not a single touch (single point touch) manipulation has been performed. That is, at step S303, it is determined as to whether or not user's input is in a “first-point touch (single point touch) start state” (where a finger has been brought into contact with a single point on the touch manipulation portion (the touch panel 24) and is still in contact therewith).

If it is detected that the single touch (single point touch) manipulation is performed (Yes at S303), the process proceeds to step S304. If not (No at S303), the process returns to step S300 to repeat the above process. That is, the process proceeds to step S300 and establishes a state for receiving next input from the user.

At step S304, a position (coordinates) where the first-point touch (single touch) start state is established is stored in, for example, the storage device 28 as P1(x1, y1). Then, the process proceeds to step S305.

At step S305, manipulation information of the user manipulation portions (the first manipulation portion 101, the second manipulation portion 102) are acquired. For example, a push/non-push state of the “+” button (the first manipulation portion 101) and a push/non-push state of the “−” button (the second manipulation portion 102) are acquired. Then, the process proceeds to step S306.

At step S306, it is determined as to whether or not the second manipulation portion (“−” button) 102 of the user manipulation portions is manipulated. If it is determined that the second manipulation portion (“−” button) 102 of the user manipulation portions is manipulated (Yes at S306), the process proceeds to step S307. If not (Not at S306), the process returns to step S300 via S11.

At step S307, for example, a value “−1” is stored in a direction flag Fdir as shown in FIG. 5B. Then, the process proceeds to step S308.

At step S308, touch start event information for a virtual second point of “pinch-in (zooming-out)” is issued.

In this embodiment, the term “virtual second point” means a point at which input is not actually performed through the touch manipulation portion (the touch panel 24) and which is generated by the emulation as a second point that is necessary for the pinch-in (zooming-out) operation.

For example, it is assumed that Dpinch represents a predetermined distance between two points and Doffset represents an offset for Dpinch (Doffset<Dpinch). Then, coordinates P2(x2, y2) of the virtual second point are calculated using the coordinates P1(x1, y1) of the first point, the distance Dpinch, the offset Doffset, and the direction flag Dfir according to the following equation:

$$\begin{matrix}P 2 ( x 2 , y 2 ) = P 1 ( x 1 , y 1 ) + ( Dpinch - Fdir \times Doffset ) \\ = ( x 1 + ( \begin{matrix}Dpinch - \\ Fdir \times Doffset\end{matrix} ) , y 1 + ( \begin{matrix}Dpinch - \\ Fdir \times Doffset\end{matrix} )\end{matrix}$$

Then, in the case of pinch-in, the point P2(P2i) can be set at a position that is distant from the point P1 by correcting the distance by Doffset using Fdir. Then, the process proceeds to step S309.

At step S309, the thus-calculated coordinates P2(P2i) are stored as coordinates of the virtual second point (for pinch-in (zooming-out)). Then, the process proceeds to step S310.

At step S310, touch ongoing event information for the virtual second point is issued (for pinch-in (zooming-out)). This is to emulate the same action (the same manipulation) as an action in which fingers are moved for a pinch-in manipulation on the touch manipulation portion (touch panel 24).

For example, it is assumed that Dmove represent a predetermined movement distance. Then, coordinates P2′ after a movement emulation is given by

$$\begin{matrix}P {2}^{′} ( x {2}^{′} , y {2}^{′} ) = P 2 + Fdir \times Dmove \\ = ( x 2 + Fdir \times Dmove , y 2 + Fdir \times Dmove ) .\end{matrix}$$

The above operation is repeated a predetermined number of times (e.g., 10 times) while P2′ is substituted into P2.

As a result of repeating the processes, in the case of pinch-in (zooming-out), the point P2i changes so as to come close to the point P1 (see FIG. 5B).

That is, an action can be emulated that is the same as the action in which fingers are moved for the pinch-in manipulation by issuing the touch ongoing event information at the position P2 when P2′ is substituted into P2. Then, the process proceeds to step S311.

At step S311, it is determined as to whether or not the above operation has been performed the predetermined number of times (e.g., 10 times). If it is determined that the above operation has been performed the predetermined number of times (Yes at S311), the process proceeds to step S312. If not (No at S311), the process returns to step S309 via S13 and the above process is repeated.

At step S312, touch end event information for the virtual second point is issued (for pinch-in (zooming-out)). Then, the process proceeds to step S313.

At step S313, for example, application software (not shown) that is provided inside or outside the electronic apparatus (tablet apparatus) 100 performs the same operation as the pinch-in (zooming-out) operation for the multitouch manipulation (input) in the manner shown in FIG. 5B. Then, the process returns to step S200 via S1, and the above process is repeated.

Then, the process returns to step S300 via S11.

Also, step S13 leads to step S320E.

The process is terminated at step S320E.

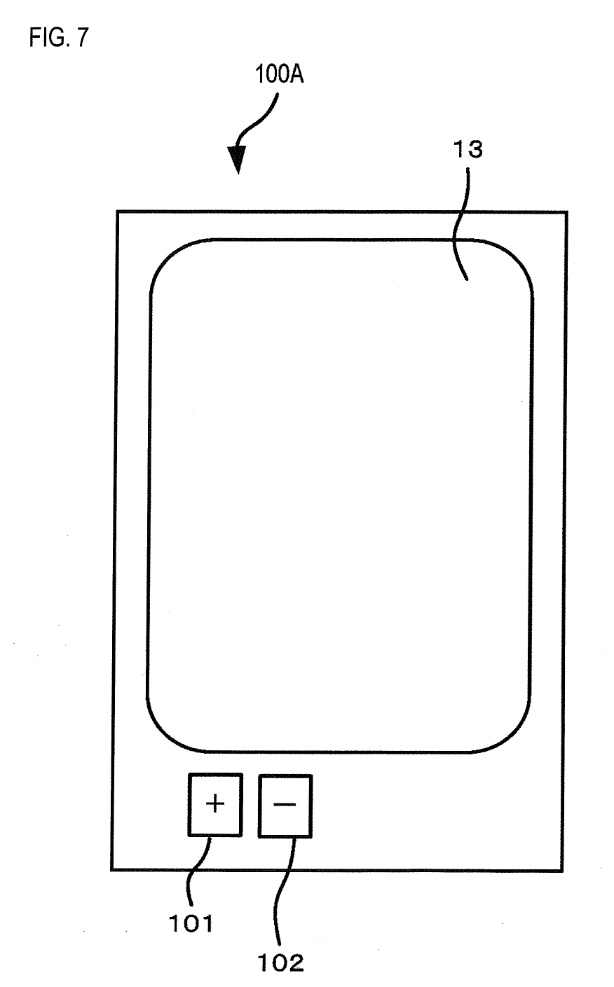

FIG. 7 shows an appearance of an electronic apparatus 100A according to another embodiment.

In this embodiment, user manipulation portions (first manipulation portion 101 and second manipulation portion 102) which can be manipulated by a user are provided separately from the touch manipulation portion.

In this embodiment, as shown in FIG. 7, the user manipulation portions (the first manipulation portion 101, the second manipulation portion 102) are provided side by side on the same surface as the video display 13 is provided.

In the above-described embodiment, an input state of the touch manipulation portion is acquired actively. Alternatively, an input state may be received passively by receiving a notice of an interrupt notice that is generated when an input to the touch manipulation portion occurs (i.e., by waiting for such a notice).

In this case, for example, subsequent processes may be initiated upon receipt of this notice as a notice.

In the first embodiment, the above “first-point touch start state” may include not only the “first-point touch start state” but also the “first-point touch on-going state” (that is, the condition is that “is user's input in the “first-point touch start state” or “the first-point touch ongoing state”?).

With this configuration, even if the user fingers move to some extent before it is determined as to whether the “+” button 101 or the “−” button 102 is pushed, the pinch-in (zooming out)/pinch-out (zooming in) manipulation is emulated as intended.

In this case, the coordinates P1 to be stored may be the last coordinates of the first-point touch ongoing state.

Also, in the above embodiment, Dpitch, Dpffset, and Fdir are used for calculating coordinates of a virtual second point. Alternatively, a simpler approach may employed. For example, distances Dpinchout and Dpinchin are set for pinch-out (zooming in) and pinch-in (zooming-out), respectively. Coordinates of a virtual second point P2 are calculated by

P2o(x2o, y2o)=(x1+Dpinchout, y1+Dpinchout)

in the case of the pinch-out (zooming-in) and by

P2io(x2i, y2i)=(x1+Dpinchin, y1+Dpinchin)

in the case of a pinch-in (zooming-out).

In the above embodiment, the predetermined Dmove and the predetermined number of times of repetition are used. Since these parameters relate to the enlargement/reduction factor, a user may be allowed to determine these parameters arbitrarily.

Even if a user is not allowed to determine these parameters arbitrarily, they may be set at small values in advance. In this case, pinch-out/pinch-in can be emulated finely though the user needs to push the“+” button 101 or the“−” button 102 a larger number of times.

In the above embodiment, every time a user pushes the “+” button 101 or the“−” button 102, event information are issued in order of (touch start)→(touch ongoing)→ . . . (prescribed number of repetitions)→(touch ongoing)→(touch end).

Alternatively, after touch start event information is issued, only touch ongoing event information may be issued every time the “+” button 101 or the“−” button 102 is pushed until touch end event information for a first point is issued (in this case, if the button 101 or 102 is manipulated before the touch manipulation end event information for a first point is issued, touch ongoing event information may be issued).

Thereby, a user who is even in a situation of holding an electronic apparatus by one hand and manipulating it with the same one hand can perform manipulation that is similar to multitouch manipulation (pinch manipulation).

Also, contents being displayed can be displayed at an arbitrary enlargement or reduction factor desired by the user.

That is, in this embodiment, the electronic apparatus 100 includes a touch manipulation portion that can receive multitouch manipulation (input).

Also, a touch input detector that is configured to detect a single touch manipulation (input) which is made with the touch manipulation portion is provided.

Also, a user manipulation portion that can be manipulated by a user is provided separately from the touch manipulation portion.

An operation module is provided. When the touch input detector detects the single touch manipulation (input) and the user manipulation portion is manipulated, the operation module is configured to perform an operation that is similar to an operation to be performed in response to the multitouch manipulation (input).

Also, the operation to be performed in response to the multitouch input may include a pinch-out (zooming-in) operation.

Also, the user manipulation portion may be configured to receive a pinch-out (zooming-in) manipulation

Also, event information indicating a virtual second point of the multitouch manipulation (input) is issued when the user manipulation portion receives the zooming-in manipulation.

Also, the event information indicating the virtual second point may be issued in plural batches.

Also, the operation to be performed in response to the multitouch manipulation (input) may include a pinch-in (zooming-out) operation

Also, the user manipulation portion may be configured to receive a pinch-in (zooming-out) manipulation

Also, event information indicating a virtual second point of the multitouch manipulation (input) may be issued when the user manipulation portion receives the pinch-in (zooming-out) manipulation.

Also, the event information indicating the virtual second point may be issued in plural batches.

With the above configuration, in the electronic apparatus according to this embodiment which can receive the multitouch manipulation (input), a user can cause the electronic apparatus to perform the operation that is similar to the operation to be performed in response to a multitouch manipulation (input) even if the user has difficulty in making the multitouch manipulation (input).

Effects of the above embodiment may easily be obtained merely by installing programs executes the control processes in an ordinary computer via a computer readable storage medium that stores the programs and by running the installed programs.

The embodiments are not limited to the above descriptions. In the practice stage, the embodiments may be embodied in such a manner that constituent elements are modified in various manners without departing from the spirit and scope thereof.

Various inventive concepts may be conceived by properly combining plural constituent elements disclosed in the respective embodiments.

For example, some of the constituent elements of each embodiment may be omitted. Furthermore, constituent elements of different embodiments may be combined as appropriate.

What is claimed is:

1. An electronic apparatus comprising:
a touch manipulation portion configured to receive a multitouch input;
a touch input detector configured to detect a single touch input that is made with the touch manipulation portion;
a user manipulation portion that is provided separately from the touch manipulation portion and that can be manipulated by a user; and
an operation module configured, when the touch input detector detects the single touch input and the user manipulation portion is manipulated, to perform an operation that is similar to an operation to be performed in response to the multitouch input.

2. The apparatus of claim 1, wherein the operation to be performed in response to the multitouch input includes a zooming-in operation.

3. The apparatus of claim 1, wherein the user manipulation portion is configured to receive a zooming-in manipulation.

4. The apparatus of claim 3, further comprising:
an event information issuing module configured to issue event information indicating a virtual second point of the multitouch input when the user manipulation portion receives the zooming-in manipulation.

5. The apparatus of claim 4, wherein the event information issuing module is configured to issue the event information indicating the virtual second point in plural batches.

6. The apparatus of claim 1, wherein the operation to be performed in response to the multitouch input includes a zooming-out operation.

7. The apparatus of claim 1, wherein the user manipulation portion is configured to receive a zooming-out manipulation.

8. The apparatus of claim 7, further comprising:
an event information issuing module configured to issue event information indicating a virtual second point of the multitouch input when the user manipulation portion receives the zooming-out manipulation.

9. The apparatus of claim 8, wherein the event information issuing module issues the event information indicating the virtual second point in plural batches.

10. A control method of an electronic apparatus including a touch manipulation portion configured to receive a multitouch input and a user manipulation portion that is provided separately from the touch manipulation portion and that can be manipulated by a user, the method comprising:
detecting a single touch input that is made with the touch manipulation portion; and
when it is detected the single touch input and the user manipulation portion is manipulated, performing an operation that is similar to an operation to be performed in response to the multitouch input.

11. A computer readable storage medium storing a program that causes a processor to execute a process for controlling an electronic apparatus including a touch manipulation portion configured to receive a multitouch input and a user manipulation portion that is provided separately from the touch manipulation portion and that can be manipulated by a user, the process comprising:
detecting a single touch input that is made with the touch manipulation portion; and
when it is detected the single touch input and the user manipulation portion is manipulated, performing an operation that is similar to an operation to be performed in response to the multitouch input.
